(19) United States
(12) Patent Application Publication
(10) Pub. No.: US 2022/0030918 A1
(43) Pub. Date: Feb. 3, 2022

(54) COMPOSITION

(71) Applicant: SUNTORY HOLDINGS LIMITED, Osaka (JP)

(72) Inventors: Akinori ITOYAMA, Kanagawa (JP); Yoji ASAMI, Kanagawa (JP); Akiko FUJIE, Kanagawa (JP); Shigeru SARADA, Kanagawa (JP)

(73) Assignee: SUNTORY HOLDINGS LIMITED, Osaka (JP)

(21) Appl. No.: 17/298,790

(22) PCT Filed: Dec. 6, 2019
(86) PCT No.: PCT/JP2019/048837

§ 371 Date: Jun. 1, 2021

(30) Foreign Application Priority Data
Dec. 7, 2018 (JP) 2018-230149

(51) Int. Cl. A23L 2/60; A23L 27/30; A23L 2/385; A23L 2/54

(52) U.S. Cl. CPC A23L 2/60; A23L 27/36; A23V 2002/00; A23L 2/54; A23L 2/385

(57) ABSTRACT

The present invention relates to beverage compositions comprising rebaudioside M (Reb M). These compositions provide conditions wherein the stability of Reb M in improved. The present invention also relates to methods of improving the stability of Reb M.

### FIELD OF THE INVENTION

The present invention relates to sweetened beverage compositions comprising the steviol glycoside rebaudioside M (Reb M). The present invention also relates to methods of improving the stability of Reb M

### BACKGROUND TO THE INVENTION

Sweeteners are used in beverages to impart a pleasant sweet taste. However, the use of caloric sweeteners such as sucrose, glucose fructose etc. has been linked to a wide array of health concerns. In particular obesity, diabetes, high cholesterol, tooth decay etc. have been linked to high sugar consumption.

Therefore, natural high intensity low-caloric sweeteners are a desirable alternative to sugars. These products possess a sweetness level many times that of sucrose and their use can substantially reduce the number of calories present in a beverage or foodstuff. However, although these products produce a very sweet taste they can have negative taste aspects, which consumers may dislike. As such there has been much research into identifying high intensity sweeteners with the most desirable taste profile i.e. one that mimics sucrose.

One of compounds that has been investigated for this reason is the steviol glycosides. These compounds are found in the leaves of the plant Stevia rebaudiana. This plant is a perennial shrub of the Asteraceae (Compositae) family which is native to certain regions of South America. The leaves of the plant have been used for hundreds of years to sweeten tea and in traditional medicines. Crude stevia extracts were first commercialised as sweeteners in Japan in the early 1970s and the stevia plant is commercially cultivated in parts of Asia and South America.

To date a large number of different sweet tasting steviol glycosides have been identified and characterised. The compounds all contain a common aglycone steviol (ent-13-hydroxykaur-16-en-19-oic acid) shown in FIG. 1. The steviol glycosides then differ in the number and type of sugars which are attached at positions C13 and C19.

| | | | Sweetness |
|---|---|---|---|
| | R groups on steviol | | potency (relative |
| Compound | R¹ | R² | to sucrose) |
| Rebaudioside A | β-glc- | (β-glc-)₂- | 200-300 |
| | | β-glc- | |
| Rebaudioside B | H | (β-glc-)₂- | 150 |
| | | β-glc- | |
| Rebaudioside C | β-glc- | (β-glc, α-rha)- | 30 |
| | | β-glc- | |
| Rebaudioside D | β-glc- β-glc- | (β-glc-)₂- | 221 |
| | | β-glc- | |
| Rebaudioside E | β-glc- β-glc- | β-glc- β-glc- | 174 |
| Rebaudioside F | β-glc- | (β-glc, β-xyl)- | 200 |
| | | β-glc- | |
| Rebaudioside M | (β-glc-)₂- β-glc- | (β-glc-)₂- | 200-250 |
| | | β-glc- | |
| Rubusoside | β-glc- | β-glc- | 114 |
| Steviolbioside | H | β-glc- β-glc- | 90 |
| Stevioside | β-glc- | β-glc- β-glc- | 150-250 |

### SUMMARY OF THE INVENTION

Out of the rebaudiosides, the minor rebaudioside M (Reb M) has recently been identified as a high potency sweetener with a clean sweet taste and minimal aftertaste. As such it may be a suitable sweetener for use in low calorie beverages. However, rebaudiosides have been shown to degrade in aqueous compositions. It has been discovered that this degradation process can produce unwanted compounds that may negatively impact the taste of a beverage. Since there is a desire to use Reb M in beverage products, there is a need to find compositions and conditions at which degradation of this high potency sweetener is reduced.

The present invention provides beverage compositions in which the stability of Reb M is improved and methods of improving Reb M stability.

Reb M is a highly desirable rebaudioside due to its clean sweet taste. It is desirable to use Reb M as a sweetening component in sweetened beverages as a low-calorie alternative to sucrose or high fructose corn syrup (HFCS). However, the present inventors have found that Reb M degrades in aqueous beverages, such as carbonated beverages. Degradation of Reb M leads to the formation of impurities and reduces the amount of rebaudioside present in a composition. As such degradation may negatively affect the taste and shelf-life of a product that has been sweetened with this rebaudioside. Therefore, the present invention provides compositions of Reb M wherein the degradation is reduced. This will allow the production of Reb M products with improved shelf-life and reduce the likelihood of forming degradation products which negatively impact the taste profile of the beverage.

The inventors have found that a low pH accelerates the degradation process. Herein it has surprisingly been found that at a pH below 2.5, degradation is disproportionately increased. Further, it appears that degradation is not only pH dependent but also concentration dependent. Surprisingly at Reb M concentrations above 100 ppm the Reb M degraded more slowly across a pH range of 2.0 to 3.5, when compared to Reb M concentrations below 100 ppm. Below pH 2.0 the concentration of Reb M does not affect the amount of degradation.

It has surprisingly been found that beverage compositions comprising Reb M at a “high” concentration from 100 ppm to 2500 ppm and with a pH in the range of 2.5-3.5 results in a more stable Reb M composition. By carefully selecting the pH and concentration of Reb M, compositions wherein the degradation of Reb M is reduced can be produced. Herein it has been shown that at a pH range of 2.0-3.5 samples containing “higher” Reb M concentrations were more stable compared to the samples containing lower concentrations. Further, at a pH above 2.5 the degradation is significantly reduced. However, a pH above 3.5 is not desirable for most beverages.

A first aspect of the present invention is a beverage composition comprising from 100 ppm to 2500 ppm of Reb M and having a pH in the range 2.0 to 3.5.

A second aspect of the invention is a beverage composition concentrate comprising from 500 ppm to 2500 ppm of Reb M and having a pH in the range 2.0 to 3.5.

A third aspect of the present invention is a method for improving the stability of Reb M in a beverage composition, comprising preparing a beverage composition comprising Reb M at a concentration of between 100 ppm to 2500 ppm and with a pH between 2.0 to 3.5.

### BRIEF DESCRIPTION OF THE DRAWINGS

FIG. 1 shows the core aglycone steviol moiety that is common between all rebaudiosides. The rebaudiosides vary in terms of the sugar moieties that are attached at C13 and C19.

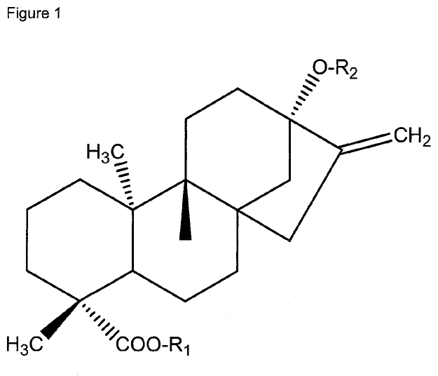

FIG. 2 shows the structure of rebaudioside M (Reb M).

FIG. 3 shows the average degradation of rebaudioside M (Reb M) of all concentration samples at different pHs.

### DETAILED DESCRIPTION

The present invention aims to produce a beverage comprising Reb M wherein the degradation of Reb M is reduced. As such, beverage compositions are provided wherein the conditions result in a more stable Reb M.

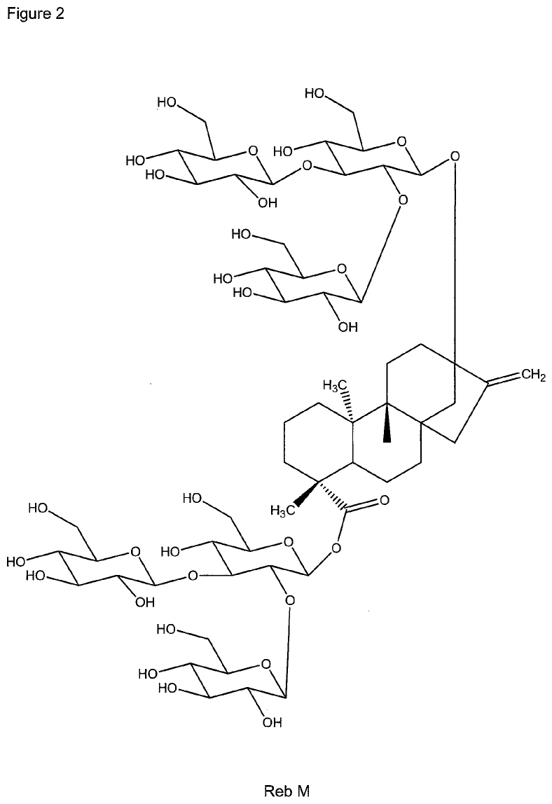

A first aspect of the invention is a beverage composition comprising from 100 ppm to 2500 ppm of Reb M and having a pH in the range 2.0 to 3.5. Reb M is a steviol glycoside with the structure according to FIG. 2. Reb M may be obtained naturally from stevia leaves, synthetically or by production in a recombinant host organism. Methods to extract Reb M are well known in the art and any of such methods may be used to prepare the Reb M for use in the present invention.

The data presented herein demonstrates that at low concentrations Reb M degrades faster between pH 2.0 to 3.5, and the concentration of Reb M required in a beverage composition may vary depending on the desired sweetness. Therefore, in an embodiment of the present invention the beverage composition comprises from 100 ppm to 2500 ppm of Reb M and a pH in the range 2.0 to 3.5. The concentration of Reb M in the beverage composition may be between 100 ppm to 2500 ppm, 150 ppm to 2500 ppm, 200 ppm to 2500 ppm, 250 ppm to 2500 ppm, 300 ppm to 2500 ppm, 400 ppm to 2500 ppm, 500 ppm to 2500 ppm, 600 ppm to 2500 ppm, 700 ppm to 2500 ppm, 800 ppm to 2500 ppm, 900 ppm to 2500 ppm, 1000 ppm to 2500 ppm, 1500 ppm to 2500 ppm, 100 ppm to 2000 ppm, 150 ppm to 2000 ppm, 200 ppm to 2000 ppm, 250 ppm to 2000 ppm, 300 ppm to 2000 ppm, 400 ppm to 2000 ppm, 500 ppm to 2000 ppm, 600 ppm to 2000 ppm, 700 ppm to 2000 ppm, 800 ppm to 2000 ppm, 900 ppm to 2000 ppm, 1000 ppm to 2000 ppm, 1500 ppm to 2000 ppm, 100 ppm to 1500 ppm, 150 ppm to 1500 ppm, 200 ppm to 1500 ppm, 250 ppm to 1500 ppm, 300 ppm to 1500 ppm, 400 ppm to 1500 ppm, 500 ppm to 1500 ppm, 600 ppm to 1500 ppm, 700 ppm to 1500 ppm, 800 ppm to 1500 ppm, 900 ppm to 1500 ppm, 1000 ppm to 1500 ppm, 100 ppm to 1200 ppm, 150 ppm to 1200 ppm, 200 ppm to 1200 ppm, 250 ppm to 1200 ppm, 300 ppm to 1200 ppm, 400 ppm to 1200 ppm, 500 ppm to 1200 ppm, 600 ppm to 1200 ppm, 700 ppm to 1200 ppm, 800 ppm to 1200 ppm, 900 ppm to 1200 ppm, 1000 ppm to 1200 ppm, 100 ppm to 1000 ppm, 150 ppm to 1000 ppm, 200 ppm to 1000 ppm, 250 pm to 1000 ppm, 300 ppm to 1000 ppm, 400 ppm to 1000 ppm, 100 ppm to 500 ppm, 150 ppm, to 500 ppm, 200 ppm to 500 ppm, 250 ppm to 500 ppm, 300 ppm to 500 ppm, 400 ppm to 500 ppm, 100 ppm to 450 ppm, 150 ppm to 450 ppm, 200 ppm to 450 ppm, 250 ppm to 450 ppm, 300 ppm to 450 ppm, 100 ppm to 400 ppm, 150 ppm to 400 ppm, 200 ppm to 400 ppm, 250 ppm to 400 ppm, 300 ppm to 400 ppm, 100 ppm to 300 ppm, 150 ppm to 300 ppm, 200 ppm to 300 ppm, 250 ppm to 300 ppm, 100 ppm to 250 ppm, 150 ppm to 250 ppm, or 200 ppm to 250 ppm.

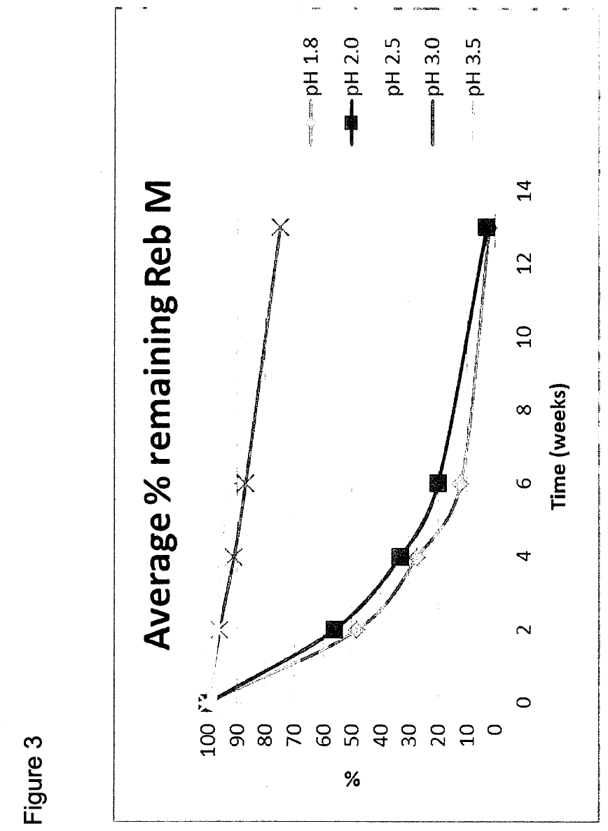

The data shown in FIG. 3 shows that overall degradation at all Reb M concentrations is reduced above pH 2.5. Reb M samples that were incubated at pH 1.8 and pH 2.0 degraded almost entirely after 13 weeks, whereas at above pH 2.0, significantly more Reb M was present after 13 weeks. Therefore, in an embodiment of the present invention, the pH of the beverage composition is between 2.3 to 3.5 and the Reb M is present in a concentration from 100 ppm to 2500 ppm, 150 ppm to 2500 ppm, 200 ppm to 2500 ppm, 250 ppm to 2500 ppm, 300 ppm to 2500 ppm, 400 ppm to 2500 ppm, 500 ppm to 2500 ppm, 600 ppm to 2500 ppm, 700 ppm to 2500 ppm, 800 ppm to 2500 ppm, 900 ppm to 2500 ppm, 1000 ppm to 2500 ppm, 1500 ppm to 2500 ppm, 100 ppm to 2000 ppm, 150 ppm to 2000 ppm, 200 ppm to 2000 ppm, 250 ppm to 2000 ppm, 300 ppm to 2000 ppm, 400 ppm to 2000 ppm, 500 ppm to 2000 ppm, 600 ppm to 2000 ppm, 700 ppm to 2000 ppm, 800 ppm to 2000 ppm, 900 ppm to 2000 ppm, 1000 ppm to 2000 ppm, 1500 ppm to 2000 ppm, 100 ppm to 1500 ppm, 150 ppm to 1500 ppm, 200 ppm to 1500 ppm, 250 ppm to 1500 ppm, 300 ppm to 1500 ppm, 400 ppm to 1500 ppm, 500 ppm to 1500 ppm, 600 ppm to 1500 ppm, 700 ppm to 1500 ppm, 800 ppm to 1500 ppm, 900 ppm to 1500 ppm, 1000 ppm to 1500 ppm, 100 ppm to 1200 ppm, 150 ppm to 1200 ppm, 200 ppm to 1200 ppm, 250 ppm to 1200 ppm, 300 ppm to 1200 ppm, 400 ppm to 1200 ppm, 500 ppm to 1200 ppm, 600 ppm to 1200 ppm, 700 ppm to 1200 ppm, 800 ppm to 1200 ppm, 900 ppm to 1200 ppm, 1000 ppm to 1200 ppm, 100 ppm to 1000 ppm, 150 ppm to 1000 ppm, 200 ppm to 1000 ppm, 250 pm to 1000 ppm, 300 ppm to 1000 ppm, 400 ppm to 1000 ppm, 100 ppm to 500 ppm, 150 ppm, to 500 ppm, 200 ppm to 500 ppm, 250 ppm to 500 ppm, 300 ppm to 500 ppm, 400 ppm to 500 ppm, 100 ppm to 450 ppm, 150 ppm to 450 ppm, 200 ppm to 450 ppm, 250 ppm to 450 ppm, 300 ppm to 450 ppm, 100 ppm to 400 ppm, 150 ppm to 400 ppm, 200 ppm to 400 ppm, 250 ppm to 400 ppm, 300 ppm to 400 ppm, 100 ppm to 300 ppm, 150 ppm to 300 ppm, 200 ppm to 300 ppm, 250 ppm to 300 ppm, 100 ppm to 250 ppm, 150 ppm to 250 ppm, or 200 ppm to 250 ppm.

In an embodiment of the present invention the pH of the beverage composition is between 2.5 to 3.5 and the Reb M is present in a concentration from 100 ppm to 2500 ppm, 150 ppm to 2500 ppm, 200 ppm to 2500 ppm, 250 ppm to 2500 ppm, 300 ppm to 2500 ppm, 400 ppm to 2500 ppm, 500 ppm to 2500 ppm, 600 ppm to 2500 ppm, 700 ppm to 2500 ppm, 800 ppm to 2500 ppm, 900 ppm to 2500 ppm, 1000 ppm to 2500 ppm, 1500 ppm to 2500 ppm, 100 ppm to 2000 ppm, 150 ppm to 2000 ppm, 200 ppm to 2000 ppm, 250 ppm to 2000 ppm, 300 ppm to 2000 ppm, 400 ppm to 2000 ppm, 500 ppm to 2000 ppm, 600 ppm to 2000 ppm, 700 ppm to 2000 ppm, 800 ppm to 2000 ppm, 900 ppm to 2000 ppm, 1000 ppm to 2000 ppm, 1500 ppm to 2000 ppm, 100 ppm to 1500 ppm, 150 ppm to 1500 ppm, 200 ppm to 1500 ppm, 250 ppm to 1500 ppm, 300 ppm to 1500 ppm, 400 ppm to 1500 ppm, 500 ppm to 1500 ppm, 600 ppm to 1500 ppm, 700 ppm to 1500 ppm, 800 ppm to 1500 ppm, 900 ppm to 1500 ppm, 1000 ppm to 1500 ppm, 100 ppm to 1200 ppm, 150 ppm to 1200 ppm, 200 ppm to 1200 ppm, 250 ppm to 1200 ppm, 300 ppm to 1200 ppm, 400 ppm to 1200 ppm, 500 ppm to 1200 ppm, 600 ppm to 1200 ppm, 700 ppm to 1200 ppm, 800 ppm to 1200 ppm, 900 ppm to 1200 ppm, 1000 ppm to 1200 ppm, 100 ppm to 1000 ppm, 150 ppm to 1000 ppm, 200 ppm to 1000 ppm, 250 pm to 1000 ppm, 300 ppm to 1000 ppm, 400 ppm to 1000 ppm, 100 ppm to 500 ppm, 150 ppm, to 500 ppm, 200 ppm to 500 ppm, 250 ppm to 500 ppm, 300 ppm to 500 ppm, 400 ppm to 500 ppm, 100 ppm to 450 ppm, 150 ppm to 450 ppm, 200 ppm to 450 ppm, 250 ppm to 450 ppm, 300 ppm to 450 ppm, 100 ppm to 400 ppm, 150 ppm to 400 ppm, 200 ppm to 400 ppm, 250 ppm to 400 ppm, 300 ppm to 400 ppm, 100 ppm to 300 ppm, 150 ppm to 300 ppm, 200 ppm to 300 ppm, 250 ppm to 300 ppm, 100 ppm to 250 ppm, 150 ppm to 250 ppm, or 200 ppm to 250 ppm.

In an embodiment of the present invention the pH of the beverage composition is between 3.0 to 3.5 and the Reb M is present in a concentration from 100 ppm to 2500 ppm, 150 ppm to 2500 ppm, 200 ppm to 2500 ppm, 250 ppm to 2500 ppm, 300 ppm to 2500 ppm, 400 ppm to 2500 ppm, 500 ppm to 2500 ppm, 600 ppm to 2500 ppm, 700 ppm to 2500 ppm, 800 ppm to 2500 ppm, 900 ppm to 2500 ppm, 1000 ppm to 2500 ppm, 1500 ppm to 2500 ppm, 100 ppm to 2000 ppm, 150 ppm to 2000 ppm, 200 ppm to 2000 ppm, 250 ppm to 2000 ppm, 300 ppm to 2000 ppm, 400 ppm to 2000 ppm, 500 ppm to 2000 ppm, 600 ppm to 2000 ppm, 700 ppm to 2000 ppm, 800 ppm to 2000 ppm, 900 ppm to 2000 ppm, 1000 ppm to 2000 ppm, 1500 ppm to 2000 ppm, 100 ppm to 1500 ppm, 150 ppm to 1500 ppm, 200 ppm to 1500 ppm, 250 ppm to 1500 ppm, 300 ppm to 1500 ppm, 400 ppm to 1500 ppm, 500 ppm to 1500 ppm, 600 ppm to 1500 ppm, 700 ppm to 1500 ppm, 800 ppm to 1500 ppm, 900 ppm to 1500 ppm, 1000 ppm to 1500 ppm, 100 ppm to 1200 ppm, 150 ppm to 1200 ppm, 200 ppm to 1200 ppm, 250 ppm to 1200 ppm, 300 ppm to 1200 ppm, 400 ppm to 1200 ppm, 500 ppm to 1200 ppm, 600 ppm to 1200 ppm, 700 ppm to 1200 ppm, 800 ppm to 1200 ppm, 900 ppm to 1200 ppm, 1000 ppm to 1200 ppm, 100 ppm to 1000 ppm, 150 ppm to 1000 ppm, 200 ppm to 1000 ppm, 250 pm to 1000 ppm, 300 ppm to 1000 ppm, 400 ppm to 1000 ppm, 100 ppm to 500 ppm, 150 ppm, to 500 ppm, 200 ppm to 500 ppm, 250 ppm to 500 ppm, 300 ppm to 500 ppm, 400 ppm to 500 ppm, 100 ppm to 450 ppm, 150 ppm to 450 ppm, 200 ppm to 450 ppm, 250 ppm to 450 ppm, 300 ppm to 450 ppm, 100 ppm to 400 ppm, 150 ppm to 400 ppm, 200 ppm to 400 ppm, 250 ppm to 400 ppm, 300 ppm to 400 ppm, 100 ppm to 300 ppm, 150 ppm to 300 ppm, 200 ppm to 300 ppm, 250 ppm to 300 ppm, 100 ppm to 250 ppm, 150 ppm to 250 ppm, or 200 ppm to 250 ppm.

Given the importance of the pH to the stability of the beverage, a buffer system is preferably used. Suitable buffer systems of use in the present invention include, by way of example only, tartaric, fumaric, maleic, phosphoric, and acetic acids and salts. Preferred buffering systems include citric acid and phosphoric acid buffer systems. The most preferred buffer system is a citric acid buffer system preferably contains sodium citrate in combination with citric acid. Preferably there is about 0.1 to about 10 grams/litre of sodium citrate, and about 0.05 to about 5 grams/liter of citric acid. Typically suitable buffer systems include those capable of maintaining a pH in the range stated in the embodiments herein. These buffer systems are known to the skilled person.

In an embodiment the beverage composition may be carbonated. As used herein a “carbonated beverage” is a beverage composition that contains carbon dioxide gas (CO₂). The presence of the CO₂ produces bubbles within the beverage.

In an embodiment the carbonated beverage composition may comprise carbon dioxide (CO₂) at a gas pressure from 1.0-3.5 kg/m³. Preferably the CO₂ is at a gas pressure from 1.5-3.0 kg/m³, more preferably the CO₂ is at a gas pressure from 2.0-3.0 kg/m³.

In another embodiment the carbonated beverage composition may comprise carbon dioxide (CO₂) at a gas pressure from 1.0-3.5 kgf/cm². Preferably the CO₂ is at a gas pressure from 1.5-3.0 kgf/cm², more preferably the CO₂ is at a gas pressure from 2.0-3.0 kg/m³.

In an embodiment the beverage composition is a carbonated beverage wherein the CO₂ is at a gas pressure from 1.5-3.0 kg/m³, and the pH of the beverage composition is from 2.3 to 3.5 and the Reb M is present in a concentration from 700 ppm to 2500 ppm, 1000 ppm to 2500 ppm, 1200 ppm to 2500 ppm, 1500 ppm to 2500 ppm.

In another embodiment the beverage composition is a carbonated beverage wherein the CO₂ is at a gas pressure from 1.5-3.0 kgf/cm², and the pH of the beverage composition is from 2.3 to 3.5 and the Reb M is present in a concentration from 700 ppm to 2500 ppm, 1000 ppm to 2500 ppm, 1200 ppm to 2500 ppm, 1500 ppm to 2500 ppm.

In an embodiment the beverage composition is a carbonated beverage composition wherein the CO₂ is at a gas pressure from 1.5-3.0 kg/m³, and the pH of the beverage composition is from 2.5 to 3.5 and the Reb M is present in a concentration from 700 ppm to 2500 ppm, 1000 ppm to 2500 ppm, 1200 ppm to 2500 ppm, 1500 ppm to 2500 ppm.

In another embodiment the beverage composition is a carbonated beverage composition wherein the CO₂ is at a gas pressure from 1.5-3.0 kgf/cm², and the pH of the beverage composition is from 2.5 to 3.5 and the Reb M is present in a concentration from 700 ppm to 2500 ppm, 1000 ppm to 2500 ppm, 1200 ppm to 2500 ppm, 1500 ppm to 2500 ppm.

In an embodiment the beverage composition is a carbonated beverage composition wherein the CO₂ is at a gas pressure from 1.5-3.0 kg/m³, and the pH of the beverage composition is from 3.0 to 3.5 and the Reb M is present in a concentration from 700 ppm to 2500 ppm, 1000 ppm to 2500 ppm, 1200 ppm to 2500 ppm, 1500 ppm to 2500 ppm.

In another embodiment the beverage composition is a carbonated beverage composition wherein the CO₂ is at a gas pressure from 1.5-3.0 kgf/cm², and the pH of the beverage composition is from 3.0 to 3.5 and the Reb M is present in a concentration from 700 ppm to 2500 ppm, 1000 ppm to 2500 ppm, 1200 ppm to 2500 ppm, 1500 ppm to 2500 ppm.

The beverage composition of the present invention may comprise Reb M as the primary sweetening component or the sole sweetening component. The beverage composition may also comprise other sweetening components such as other steviol sweeteners. Non-limiting examples of steviol sweeteners include Reb A, Reb B, Reb C, Reb D, Reb E, Reb F, Reb I, Reb H, Reb L, Reb K, Reb J, Reb N, Reb O, dulcoside A, dulcoside B, stevioside, steviolbioside, rubusoside.

Where Reb M is the sole sweetening component, any interactions with other sweetening components which may lead to a decrease in the stability of the Reb M is avoided. Such a decrease in stability may arise as a consequence of Reb M-sweetener interactions, or Reb M-sweetener decomposition product interactions.

The beverage composition may also comprise additional carbohydrate based sweeteners, non-limiting examples include sucrose, fructose, glucose, erythritol, maltitol, lactitol, sorbitol, mannitol, xylitol, tagatose, trehalose, galactose, rhamnose, cyclodextrin, ribulose, threose, arabinose, xylose, lyxose, allose, altrose, mannose, idose, lactose, maltose, invert sugar, isotrehalose, neotrehalose, palatinose or isomaltulose, erythrose, deoxyribose, gulose, idose, talose, erythrulose, xylulose, psicose, turanose, cellobiose, glucosamine, mannosamine, fucose, fuculose, glucuronic acid, gluconic acid, glucono-lactone, abequose, galactosamine, xylo-oligosaccharides (xylotriose, xylobiose and the like), gentio-oligoscaccharides (gentiobiose, gentiotriose, gentiotetraose, galacto-oligosaccharides, sorbose, ketotriose (dehydroxyacetone), aldotriose (glyceraldehyde), nigero-oligosaccharides, fructooligosaccharides (kestose, nystose and the like), maltotetraose, maltotriol, tetrasaccharides, mannan-oligosaccharides, maltooligosaccharides (maltotriose, maltotetraose, maltopentaose, maltohexaose, maltoheptaose), dextrins, lactulose, melibiose, raffinose, rhamnose, ribose, isomerized liquid sugars such as high fructose corn syrup (HFCS e.g., HFCS55, HFCS42, or HFCS90), coupling sugars, soybean oligosaccharides, glucose syrup and combinations thereof. D- or L-configurations can be used when applicable.

In a preferred embodiment the additional sweetener is selected from sucrose, glucose, fructose and/or HFCS.

Additional sweetening components may be selected from natural high potency sweeteners such as mogroside IV, mogroside V, Luo Han Guo, siamenoside, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, and cyclocarioside I.

Additional sweetening components may be synthetic sweeteners. As used herein, the phrase “synthetic sweetener” refers to any composition which is not found naturally in nature and characteristically has a sweetness potency greater than sucrose, fructose, or glucose, yet has less calories. Non-limiting examples of synthetic high-potency sweeteners suitable for embodiments of this disclosure include sucralose, potassium acesulfame, acesulfame acid and salts thereof, aspartame, alitame, saccharin and salts thereof, neohesperidin dihydrochalcone, cyclamate, cyclamic acid and salts thereof, neotame, advantame, glucosylated steviol glycosides (GSGs) and combinations thereof.

Any of the additional sweetening components, either carbohydrate sweeteners, natural high potency sweeteners or synthetic sweeteners may be present in the beverage composition in a concentration from about 0.3 ppm to about 3,500 ppm.

The amount of sucrose in a reference solution may be described in degrees Brix (° Bx). One degree Brix is 1 gram of sucrose in 100 grams of solution and represents the strength of the solution as percentage by weight (% w/w). In one embodiment, a beverage composition contains Reb M in an amount effective to provide sweetness equivalent from about 0.50 to 15 degrees Brix of sucrose when present in a sweetened composition, such as, for example, from 5 to 11 degrees Brix, from 4 to 7 degrees Brix, or about 5 degrees Brix. In another embodiment, Reb M is present in an amount effective to provide sweetness equivalent to about 10 degrees Brix.

The term “about” as used herein indicates that a margin of +/−10% is applicable to the stated value.

In various embodiments of the present invention the total sweetness of the beverage composition is equivalent to 5 to 15 degrees Brix, preferably 7 to 12 degrees Brix, more preferably 9 to 11 degrees Brix. Most preferably the total sweetness of the beverage composition is equivalent to about 10 degrees Brix.

In addition to Reb M, and optionally other sweetening components, the beverage composition can optionally include further additives, detailed herein below. In some embodiments, the sweetener composition contains additives such as, carbohydrates, polyols, amino acids and their corresponding salts, poly-amino acids and their corresponding salts, sugar acids and their corresponding salts, nucleotides, organic acids, inorganic acids, organic salts including organic acid salts and organic base salts, inorganic salts, bitter compounds, flavorants and flavoring ingredients, astringent compounds, proteins or protein hydrolysates, surfactants, emulsifiers, weighing agents, gums, antioxidants, colorants, flavonoids, alcohols, polymers and combinations thereof. In some embodiments, the additives act to improve the temporal and flavor profile of the sweetener to provide a beverage composition with excellent taste properties.

In a preferred embodiment the beverage composition may also comprise cinnamaldehyde, caffeine, caramel colouring and/or phosphoric acid

The beverages which are suitable for the present invention include ready-to-drink beverage, a beverage composition concentrate, a beverage composition syrup, or a powdered beverage. Suitable ready-to-drink beverages include carbonated and non-carbonated beverages. Carbonated beverages include, but are not limited to, enhanced sparkling beverages, cola, lemon-lime flavored sparkling beverage, orange flavored sparkling beverage, grape flavored sparkling beverage, strawberry flavored sparkling beverage, pineapple flavored sparkling beverage, ginger-ale, soft drinks and root beer. Non-carbonated beverages include, but are not limited to fruit juice, fruit-flavored juice, juice drinks, nectars, vegetable juice, vegetable-flavored juice, sports drinks, energy drinks, enhanced water drinks, enhanced water with vitamins, near water drinks (e.g., water with natural or synthetic flavorants), coconut water, tea type drinks (e.g. black tea, green tea, red tea, oolong tea), coffee, cocoa drink, milk beverages, coffee containing milk components, café au lait, milk tea, fruit milk beverages, beverages containing cereal extracts, smoothies and combinations thereof.

The data herein demonstrate that Reb M is more stable at higher concentrations. Therefore a second aspect of the present invention is a beverage composition concentrate comprising from 500 ppm to 2500 ppm of Reb M and having a pH in the range 2.0 to 3.5.

As used herein the term “beverage composition concentrate” also refers to “beverage composition syrup”. Beverage composition concentrates and beverage composition syrups are prepared with an initial volume of liquid (e.g. water) and the desired beverage composition ingredients. These products are more concentrated than a ready to drink beverage. A ready to drink beverage composition can be prepared from a concentrate or syrup by adding further volumes of liquid. A beverage composition concentrate may be from 3 to 15 fold more concentrated, or from 5 to 15 fold more concentrated, or from 8 to 12 fold more concentrated, or from 9 to 11 fold more concentrated than the ready to drink beverage.

In an embodiment the pH of the beverage composition concentrate is from 2.0 to 3.5 and Reb M is present in a concentration from 500 ppm to 2500 ppm, 600 ppm to 2500 ppm, 700 ppm to 2500 ppm, 800 to 2500 ppm, 900 ppm to 2500 ppm, 1000 ppm to 2500 ppm, 1100 ppm to 2500 ppm, 1200 ppm to 2500 ppm, 1300 ppm to 2500 ppm, 1400 ppm to 2500 ppm, 1500 ppm to 2500 ppm, 1600 ppm to 2500 ppm, 1700 ppm to 2500 ppm, 1800 ppm to 2500 ppm, 1900 ppm to 2500 ppm, 2000 ppm to 2500 ppm, 2100 ppm to 2500 ppm, 2200 ppm to 2500 ppm, 2300 ppm to 2500 ppm, 2400 ppm to 2500 ppm, 500 ppm to 2000 ppm, 600 ppm to 2000 ppm, 700 ppm to 2000 ppm, 800 to 2000 ppm, 900 ppm to 2000 ppm, 1000 ppm to 2000 ppm, 1100 ppm to 2000 ppm, 1200 ppm to 2000 ppm, 1300 ppm to 2000 ppm, 1400 ppm to 2000 ppm, 1500 ppm to 2000 ppm, 1600 ppm to 2000 ppm, 1700 ppm to 2000 ppm, 1800 ppm to 2000 ppm, 1900 ppm to 2000 ppm, 500 ppm to 1800 ppm, 600 ppm to 1800 ppm, 700 ppm to 1800 ppm, 800 to 1800 ppm, 900 ppm to 1800 ppm, 1000 ppm to 1800 ppm, 1100 ppm to 1800 ppm, 1200 ppm to 1800 ppm, 1300 ppm to 1800 ppm, 1400 ppm to 1800 ppm, 1500 ppm to 1800 ppm, 1600 ppm to 1800 ppm, 1700 ppm to 1800 ppm, 500 ppm to 1500 ppm, 600 ppm to 1500 ppm, 700 ppm to 1500 ppm, 800 to 1500 ppm, 900 ppm to 1500 ppm, 1000 ppm to 1500 ppm, 1100 ppm to 1500 ppm, 1200 ppm to 1500 ppm, 1300 ppm to 1500 ppm, or 1400 ppm to 1500 ppm.

In an embodiment the pH of the beverage composition concentrate is from 2.3 to 3.5 and Reb M is present in a concentration from 500 ppm to 2500 ppm, 600 ppm to 2500 ppm, 700 ppm to 2500 ppm, 800 to 2500 ppm, 900 ppm to 2500 ppm, 1000 ppm to 2500 ppm, 1100 ppm to 2500 ppm, 1200 ppm to 2500 ppm, 1300 ppm to 2500 ppm, 1400 ppm to 2500 ppm, 1500 ppm to 2500 ppm, 1600 ppm to 2500 ppm, 1700 ppm to 2500 ppm, 1800 ppm to 2500 ppm, 1900 ppm to 2500 ppm, 2000 ppm to 2500 ppm, 2100 ppm to 2500 ppm, 2200 ppm to 2500 ppm, 2300 ppm to 2500 ppm, 2400 ppm to 2500 ppm, 500 ppm to 2000 ppm, 600 ppm to 2000 ppm, 700 ppm to 2000 ppm, 800 to 2000 ppm, 900 ppm to 2000 ppm, 1000 ppm to 2000 ppm, 1100 ppm to 2000 ppm, 1200 ppm to 2000 ppm, 1300 ppm to 2000 ppm, 1400 ppm to 2000 ppm, 1500 ppm to 2000 ppm, 1600 ppm to 2000 ppm, 1700 ppm to 2000 ppm, 1800 ppm to 2000 ppm, 1900 ppm to 2000 ppm, 500 ppm to 1800 ppm, 600 ppm to 1800 ppm, 700 ppm to 1800 ppm, 800 to 1800 ppm, 900 ppm to 1800 ppm, 1000 ppm to 1800 ppm, 1100 ppm to 1800 ppm, 1200 ppm to 1800 ppm, 1300 ppm to 1800 ppm, 1400 ppm to 1800 ppm, 1500 ppm to 1800 ppm, 1600 ppm to 1800 ppm, 1700 ppm to 1800 ppm, 500 ppm to 1500 ppm, 600 ppm to 1500 ppm, 700 ppm to 1500 ppm, 800 to 1500 ppm, 900 ppm to 1500 ppm, 1000 ppm to 1500 ppm, 1100 ppm to 1500 ppm, 1200 ppm to 1500 ppm, 1300 ppm to 1500 ppm, or 1400 ppm to 1500 ppm.

In an embodiment the pH of the beverage composition concentrate is from 2.5 to 3.5 and Reb M is present in a concentration from 500 ppm to 2500 ppm, 600 ppm to 2500 ppm, 700 ppm to 2500 ppm, 800 to 2500 ppm, 900 ppm to 2500 ppm, 1000 ppm to 2500 ppm, 1100 ppm to 2500 ppm, 1200 ppm to 2500 ppm, 1300 ppm to 2500 ppm, 1400 ppm to 2500 ppm, 1500 ppm to 2500 ppm, 1600 ppm to 2500 ppm, 1700 ppm to 2500 ppm, 1800 ppm to 2500 ppm, 1900 ppm to 2500 ppm, 2000 ppm to 2500 ppm, 2100 ppm to 2500 ppm, 2200 ppm to 2500 ppm, 2300 ppm to 2500 ppm, 2400 ppm to 2500 ppm, 500 ppm to 2000 ppm, 600 ppm to 2000 ppm, 700 ppm to 2000 ppm, 800 to 2000 ppm, 900 ppm to 2000 ppm, 1000 ppm to 2000 ppm, 1100 ppm to 2000 ppm, 1200 ppm to 2000 ppm, 1300 ppm to 2000 ppm, 1400 ppm to 2000 ppm, 1500 ppm to 2000 ppm, 1600 ppm to 2000 ppm, 1700 ppm to 2000 ppm, 1800 ppm to 2000 ppm, 1900 ppm to 2000 ppm, 500 ppm to 1800 ppm, 600 ppm to 1800 ppm, 700 ppm to 1800 ppm, 800 to 1800 ppm, 900 ppm to 1800 ppm, 1000 ppm to 1800 ppm, 1100 ppm to 1800 ppm, 1200 ppm to 1800 ppm, 1300 ppm to 1800 ppm, 1400 ppm to 1800 ppm, 1500 ppm to 1800 ppm, 1600 ppm to 1800 ppm, 1700 ppm to 1800 ppm, 500 ppm to 1500 ppm, 600 ppm to 1500 ppm, 700 ppm to 1500 ppm, 800 to 1500 ppm, 900 ppm to 1500 ppm, 1000 ppm to 1500 ppm, 1100 ppm to 1500 ppm, 1200 ppm to 1500 ppm, 1300 ppm to 1500 ppm, or 1400 ppm to 1500 ppm.

In an embodiment the pH of the beverage composition concentrate is from 3.0 to 3.5 and Reb M is present in a concentration from 500 ppm to 2500 ppm, 600 ppm to 2500 ppm, 700 ppm to 2500 ppm, 800 to 2500 ppm, 900 ppm to 2500 ppm, 1000 ppm to 2500 ppm, 1100 ppm to 2500 ppm, 1200 ppm to 2500 ppm, 1300 ppm to 2500 ppm, 1400 ppm to 2500 ppm, 1500 ppm to 2500 ppm, 1600 ppm to 2500 ppm, 1700 ppm to 2500 ppm, 1800 ppm to 2500 ppm, 1900 ppm to 2500 ppm, 2000 ppm to 2500 ppm, 2100 ppm to 2500 ppm, 2200 ppm to 2500 ppm, 2300 ppm to 2500 ppm, 2400 ppm to 2500 ppm, 500 ppm to 2000 ppm, 600 ppm to 2000 ppm, 700 ppm to 2000 ppm, 800 to 2000 ppm, 900 ppm to 2000 ppm, 1000 ppm to 2000 ppm, 1100 ppm to 2000 ppm, 1200 ppm to 2000 ppm, 1300 ppm to 2000 ppm, 1400 ppm to 2000 ppm, 1500 ppm to 2000 ppm, 1600 ppm to 2000 ppm, 1700 ppm to 2000 ppm, 1800 ppm to 2000 ppm, 1900 ppm to 2000 ppm, 500 ppm to 1800 ppm, 600 ppm to 1800 ppm, 700 ppm to 1800 ppm, 800 to 1800 ppm, 900 ppm to 1800 ppm, 1000 ppm to 1800 ppm, 1100 ppm to 1800 ppm, 1200 ppm to 1800 ppm, 1300 ppm to 1800 ppm, 1400 ppm to 1800 ppm, 1500 ppm to 1800 ppm, 1600 ppm to 1800 ppm, 1700 ppm to 1800 ppm, 500 ppm to 1500 ppm, 600 ppm to 1500 ppm, 700 ppm to 1500 ppm, 800 to 1500 ppm, 900 ppm to 1500 ppm, 1000 ppm to 1500 ppm, 1100 ppm to 1500 ppm, 1200 ppm to 1500 ppm, 1300 ppm to 1500 ppm, or 1400 ppm to 1500 ppm.

In order produce a ready to drink beverage composition from the beverage composition concentrate additional liquid is required to dilute the concentrate. Suitable liquids include water, carbonated water deionized water, distilled water, reverse osmosis water, carbon-treated water, purified water, demineralized water. Wherein carbonated water is used the water may comprise CO₂ at a gas pressure from 1.0-3.5 kg/m³. Preferably the CO₂ is at a gas pressure from 1.5-3.0 kg/m³, more preferably the CO₂ is at a gas pressure from 2.0-3.0 kg/m³.

In another embodiment, wherein carbonated water is used the water may comprise CO₂ at a gas pressure from 1.0-3.5 kgf/cm². Preferably the CO₂ is at a gas pressure from 1.5-3.0 kgf/cm², more preferably the CO₂ is at a gas pressure from 2.0-3.0 kgf/cm².

According to the second aspect of the invention the beverage composition concentrate may comprise any of the additional sweetening agents that have been listed above according to the first aspect of the invention.

According to the second aspect of the invention the beverage composition concentrate may comprise a buffer system, as described hereinbefore.

The data presented herein demonstrates that it is possible to improve the stability of Reb M in a beverage composition by controlling the pH and the concentration of Reb M. Improving the stability of Reb M means that less of the compound degrades over time. Accordingly a third aspect of the present invention is a method for improving the stability of Reb M in a beverage, comprising preparing a beverage composition comprising Reb M at a concentration between 100 ppm to 2500 ppm and with a pH between 2.0 to 3.5. This has the benefit of producing beverages with better shelf life as the sweetening agent will remain more stable. As such provided herein is a method is to improve the shelf life of a beverage composition product comprising Reb M.

An embodiment of the third aspect of the invention comprises preparing a beverage composition comprising Reb M at a concentration from 100 ppm to 2500 ppm, 150 ppm to 2500 ppm, 200 ppm to 2500 ppm, 250 ppm to 2500 ppm, 300 ppm to 2500 ppm, 400 ppm to 2500 ppm, 500 ppm to 2500 ppm, 600 ppm to 2500 ppm, 700 ppm to 2500 ppm, 800 ppm to 2500 ppm, 900 ppm to 2500 ppm, 1000 ppm to 2500 ppm, 1500 ppm to 2500 ppm, 100 ppm to 2000 ppm, 150 ppm to 2000 ppm, 200 ppm to 2000 ppm, 250 ppm to 2000 ppm, 300 ppm to 2000 ppm, 400 ppm to 2000 ppm, 500 ppm to 2000 ppm, 600 ppm to 2000 ppm, 700 ppm to 2000 ppm, 800 ppm to 2000 ppm, 900 ppm to 2000 ppm, 1000 ppm to 2000 ppm, 1500 ppm to 2000 ppm, 100 ppm to 1500 ppm, 150 ppm to 1500 ppm, 200 ppm to 1500 ppm, 250 ppm to 1500 ppm, 300 ppm to 1500 ppm, 400 ppm to 1500 ppm, 500 ppm to 1500 ppm, 600 ppm to 1500 ppm, 700 ppm to 1500 ppm, 800 ppm to 1500 ppm, 900 ppm to 1500 ppm, 1000 ppm to 1500 ppm, 100 ppm to 1200 ppm, 150 ppm to 1200 ppm, 200 ppm to 1200 ppm, 250 ppm to 1200 ppm, 300 ppm to 1200 ppm, 400 ppm to 1200 ppm, 500 ppm to 1200 ppm, 600 ppm to 1200 ppm, 700 ppm to 1200 ppm, 800 ppm to 1200 ppm, 900 ppm to 1200 ppm, 1000 ppm to 1200 ppm, 100 ppm to 1000 ppm, 150 ppm to 1000 ppm, 200 ppm to 1000 ppm, 250 pm to 1000 ppm, 300 ppm to 1000 ppm, 400 ppm to 1000 ppm, 100 ppm to 500 ppm, 150 ppm, to 500 ppm, 200 ppm to 500 ppm, 250 ppm to 500 ppm, 300 ppm to 500 ppm, 400 ppm to 500 ppm, 100 ppm to 450 ppm, 150 ppm to 450 ppm, 200 ppm to 450 ppm, 250 ppm to 450 ppm, 300 ppm to 450 ppm, 100 ppm to 400 ppm, 150 ppm to 400 ppm, 200 ppm to 400 ppm, 250 ppm to 400 ppm, 300 ppm to 400 ppm, 100 ppm to 300 ppm, 150 ppm to 300 ppm, 200 ppm to 300 ppm, 250 ppm to 300 ppm, 100 ppm to 250 ppm, 150 ppm to 250 ppm, or 200 ppm to 250 ppm, and wherein the pH is between 2.3 and 3.5.

An embodiment of the third aspect of the invention comprises preparing a beverage composition comprising Reb M at a concentration from 100 ppm to 2500 ppm, 150 ppm to 2500 ppm, 200 ppm to 2500 ppm, 250 ppm to 2500 ppm, 300 ppm to 2500 ppm, 400 ppm to 2500 ppm, 500 ppm to 2500 ppm, 600 ppm to 2500 ppm, 700 ppm to 2500 ppm, 800 ppm to 2500 ppm, 900 ppm to 2500 ppm, 1000 ppm to 2500 ppm, 1500 ppm to 2500 ppm, 100 ppm to 2000 ppm, 150 ppm to 2000 ppm, 200 ppm to 2000 ppm, 250 ppm to 2000 ppm, 300 ppm to 2000 ppm, 400 ppm to 2000 ppm, 500 ppm to 2000 ppm, 600 ppm to 2000 ppm, 700 ppm to 2000 ppm, 800 ppm to 2000 ppm, 900 ppm to 2000 ppm, 1000 ppm to 2000 ppm, 1500 ppm to 2000 ppm, 100 ppm to 1500 ppm, 150 ppm to 1500 ppm, 200 ppm to 1500 ppm, 250 ppm to 1500 ppm, 300 ppm to 1500 ppm, 400 ppm to 1500 ppm, 500 ppm to 1500 ppm, 600 ppm to 1500 ppm, 700 ppm to 1500 ppm, 800 ppm to 1500 ppm, 900 ppm to 1500 ppm, 1000 ppm to 1500 ppm, 100 ppm to 1200 ppm, 150 ppm to 1200 ppm, 200 ppm to 1200 ppm, 250 ppm to 1200 ppm, 300 ppm to 1200 ppm, 400 ppm to 1200 ppm, 500 ppm to 1200 ppm, 600 ppm to 1200 ppm, 700 ppm to 1200 ppm, 800 ppm to 1200 ppm, 900 ppm to 1200 ppm, 1000 ppm to 1200 ppm, 100 ppm to 1000 ppm, 150 ppm to 1000 ppm, 200 ppm to 1000 ppm, 250 pm to 1000 ppm, 300 ppm to 1000 ppm, 400 ppm to 1000 ppm, 100 ppm to 500 ppm, 150 ppm, to 500 ppm, 200 ppm to 500 ppm, 250 ppm to 500 ppm, 300 ppm to 500 ppm, 400 ppm to 500 ppm, 100 ppm to 450 ppm, 150 ppm to 450 ppm, 200 ppm to 450 ppm, 250 ppm to 450 ppm, 300 ppm to 450 ppm, 100 ppm to 400 ppm, 150 ppm to 400 ppm, 200 ppm to 400 ppm, 250 ppm to 400 ppm, 300 ppm to 400 ppm, 100 ppm to 300 ppm, 150 ppm to 300 ppm, 200 ppm to 300 ppm, 250 ppm to 300 ppm, 100 ppm to 250 ppm, 150 ppm to 250 ppm, or 200 ppm to 250 ppm, and wherein the pH is between 2.5 and 3.5.

An embodiment of the third aspect of the invention comprises preparing a beverage composition comprising Reb M at a concentration from 100 ppm to 2500 ppm, 150 ppm to 2500 ppm, 200 ppm to 2500 ppm, 250 ppm to 2500 ppm, 300 ppm to 2500 ppm, 400 ppm to 2500 ppm, 500 ppm to 2500 ppm, 600 ppm to 2500 ppm, 700 ppm to 2500 ppm, 800 ppm to 2500 ppm, 900 ppm to 2500 ppm, 1000 ppm to 2500 ppm, 1500 ppm to 2500 ppm, 100 ppm to 2000 ppm, 150 ppm to 2000 ppm, 200 ppm to 2000 ppm, 250 ppm to 2000 ppm, 300 ppm to 2000 ppm, 400 ppm to 2000 ppm, 500 ppm to 2000 ppm, 600 ppm to 2000 ppm, 700 ppm to 2000 ppm, 800 ppm to 2000 ppm, 900 ppm to 2000 ppm, 1000 ppm to 2000 ppm, 1500 ppm to 2000 ppm, 100 ppm to 1500 ppm, 150 ppm to 1500 ppm, 200 ppm to 1500 ppm, 250 ppm to 1500 ppm, 300 ppm to 1500 ppm, 400 ppm to 1500 ppm, 500 ppm to 1500 ppm, 600 ppm to 1500 ppm, 700 ppm to 1500 ppm, 800 ppm to 1500 ppm, 900 ppm to 1500 ppm, 1000 ppm to 1500 ppm, 100 ppm to 1200 ppm, 150 ppm to 1200 ppm, 200 ppm to 1200 ppm, 250 ppm to 1200 ppm, 300 ppm to 1200 ppm, 400 ppm to 1200 ppm, 500 ppm to 1200 ppm, 600 ppm to 1200 ppm, 700 ppm to 1200 ppm, 800 ppm to 1200 ppm, 900 ppm to 1200 ppm, 1000 ppm to 1200 ppm, 100 ppm to 1000 ppm, 150 ppm to 1000 ppm, 200 ppm to 1000 ppm, 250 pm to 1000 ppm, 300 ppm to 1000 ppm, 400 ppm to 1000 ppm, 100 ppm to 500 ppm, 150 ppm, to 500 ppm, 200 ppm to 500 ppm, 250 ppm to 500 ppm, 300 ppm to 500 ppm, 400 ppm to 500 ppm, 100 ppm to 450 ppm, 150 ppm to 450 ppm, 200 ppm to 450 ppm, 250 ppm to 450 ppm, 300 ppm to 450 ppm, 100 ppm to 400 ppm, 150 ppm to 400 ppm, 200 ppm to 400 ppm, 250 ppm to 400 ppm, 300 ppm to 400 ppm, 100 ppm to 300 ppm, 150 ppm to 300 ppm, 200 ppm to 300 ppm, 250 ppm to 300 ppm, 100 ppm to 250 ppm, 150 ppm to 250 ppm, or 200 ppm to 250 ppm, and wherein the pH is between 3.0 and 3.5.

An embodiment of the third aspect of the invention comprises preparing a beverage composition concentrate comprising Reb M at a concentration from 500 ppm to 2500 ppm, 600 ppm to 2500 ppm, 700 ppm to 2500 ppm, 800 to 2500 ppm, 900 ppm to 2500 ppm, 1000 ppm to 2500 ppm, 1100 ppm to 2500 ppm, 1200 ppm to 2500 ppm, 1300 ppm to 2500 ppm, 1400 ppm to 2500 ppm, 1500 ppm to 2500 ppm, 1600 ppm to 2500 ppm, 1700 ppm to 2500 ppm, 1800 ppm to 2500 ppm, 1900 ppm to 2500 ppm, 2000 ppm to 2500 ppm, 2100 ppm to 2500 ppm, 2200 ppm to 2500 ppm, 2300 ppm to 2500 ppm, 2400 ppm to 2500 ppm, 500 ppm to 2000 ppm, 600 ppm to 2000 ppm, 700 ppm to 2000 ppm, 800 to 2000 ppm, 900 ppm to 2000 ppm, 1000 ppm to 2000 ppm, 1100 ppm to 2000 ppm, 1200 ppm to 2000 ppm, 1300 ppm to 2000 ppm, 1400 ppm to 2000 ppm, 1500 ppm to 2000 ppm, 1600 ppm to 2000 ppm, 1700 ppm to 2000 ppm, 1800 ppm to 2000 ppm, 1900 ppm to 2000 ppm, 500 ppm to 1800 ppm, 600 ppm to 1800 ppm, 700 ppm to 1800 ppm, 800 to 1800 ppm, 900 ppm to 1800 ppm, 1000 ppm to 1800 ppm, 1100 ppm to 1800 ppm, 1200 ppm to 1800 ppm, 1300 ppm to 1800 ppm, 1400 ppm to 1800 ppm, 1500 ppm to 1800 ppm, 1600 ppm to 1800 ppm, 1700 ppm to 1800 ppm, 500 ppm to 1500 ppm, 600 ppm to 1500 ppm, 700 ppm to 1500 ppm, 800 to 1500 ppm, 900 ppm to 1500 ppm, 1000 ppm to 1500 ppm, 1100 ppm to 1500 ppm, 1200 ppm to 1500 ppm, 1300 ppm to 1500 ppm, or 1400 ppm to 1500 ppm, and wherein the pH is between 2.3 and 3.5.

An embodiment of the third aspect of the invention comprises preparing a beverage composition concentrate comprising Reb M at a concentration from 500 ppm to 2500 ppm, 600 ppm to 2500 ppm, 700 ppm to 2500 ppm, 800 to 2500 ppm, 900 ppm to 2500 ppm, 1000 ppm to 2500 ppm, 1100 ppm to 2500 ppm, 1200 ppm to 2500 ppm, 1300 ppm to 2500 ppm, 1400 ppm to 2500 ppm, 1500 ppm to 2500 ppm, 1600 ppm to 2500 ppm, 1700 ppm to 2500 ppm, 1800 ppm to 2500 ppm, 1900 ppm to 2500 ppm, 2000 ppm to 2500 ppm, 2100 ppm to 2500 ppm, 2200 ppm to 2500 ppm, 2300 ppm to 2500 ppm, 2400 ppm to 2500 ppm, 500 ppm to 2000 ppm, 600 ppm to 2000 ppm, 700 ppm to 2000 ppm, 800 to 2000 ppm, 900 ppm to 2000 ppm, 1000 ppm to 2000 ppm, 1100 ppm to 2000 ppm, 1200 ppm to 2000 ppm, 1300 ppm to 2000 ppm, 1400 ppm to 2000 ppm, 1500 ppm to 2000 ppm, 1600 ppm to 2000 ppm, 1700 ppm to 2000 ppm, 1800 ppm to 2000 ppm, 1900 ppm to 2000 ppm, 500 ppm to 1800 ppm, 600 ppm to 1800 ppm, 700 ppm to 1800 ppm, 800 to 1800 ppm, 900 ppm to 1800 ppm, 1000 ppm to 1800 ppm, 1100 ppm to 1800 ppm, 1200 ppm to 1800 ppm, 1300 ppm to 1800 ppm, 1400 ppm to 1800 ppm, 1500 ppm to 1800 ppm, 1600 ppm to 1800 ppm, 1700 ppm to 1800 ppm, 500 ppm to 1500 ppm, 600 ppm to 1500 ppm, 700 ppm to 1500 ppm, 800 to 1500 ppm, 900 ppm to 1500 ppm, 1000 ppm to 1500 ppm, 1100 ppm to 1500 ppm, 1200 ppm to 1500 ppm, 1300 ppm to 1500 ppm, or 1400 ppm to 1500 ppm, and wherein the pH is between 2.5 and 3.5.

An embodiment of the third aspect of the invention comprises preparing a beverage composition concentrate comprising Reb M at a concentration from 500 ppm to 2500 ppm, 600 ppm to 2500 ppm, 700 ppm to 2500 ppm, 800 to 2500 ppm, 900 ppm to 2500 ppm, 1000 ppm to 2500 ppm, 1100 ppm to 2500 ppm, 1200 ppm to 2500 ppm, 1300 ppm to 2500 ppm, 1400 ppm to 2500 ppm, 1500 ppm to 2500 ppm, 1600 ppm to 2500 ppm, 1700 ppm to 2500 ppm, 1800 ppm to 2500 ppm, 1900 ppm to 2500 ppm, 2000 ppm to 2500 ppm, 2100 ppm to 2500 ppm, 2200 ppm to 2500 ppm, 2300 ppm to 2500 ppm, 2400 ppm to 2500 ppm, 500 ppm to 2000 ppm, 600 ppm to 2000 ppm, 700 ppm to 2000 ppm, 800 to 2000 ppm, 900 ppm to 2000 ppm, 1000 ppm to 2000 ppm, 1100 ppm to 2000 ppm, 1200 ppm to 2000 ppm, 1300 ppm to 2000 ppm, 1400 ppm to 2000 ppm, 1500 ppm to 2000 ppm, 1600 ppm to 2000 ppm, 1700 ppm to 2000 ppm, 1800 ppm to 2000 ppm, 1900 ppm to 2000 ppm, 500 ppm to 1800 ppm, 600 ppm to 1800 ppm, 700 ppm to 1800 ppm, 800 to 1800 ppm, 900 ppm to 1800 ppm, 1000 ppm to 1800 ppm, 1100 ppm to 1800 ppm, 1200 ppm to 1800 ppm, 1300 ppm to 1800 ppm, 1400 ppm to 1800 ppm, 1500 ppm to 1800 ppm, 1600 ppm to 1800 ppm, 1700 ppm to 1800 ppm, 500 ppm to 1500 ppm, 600 ppm to 1500 ppm, 700 ppm to 1500 ppm, 800 to 1500 ppm, 900 ppm to 1500 ppm, 1000 ppm to 1500 ppm, 1100 ppm to 1500 ppm, 1200 ppm to 1500 ppm, 1300 ppm to 1500 ppm, or 1400 ppm to 1500 ppm, and wherein the pH is between 3.0 and 3.5.

The method according to the third aspect of the invention may comprise preparing a carbonated beverage. The gas pressure may be from 1.0-3.5 kg/m³. Preferably the CO₂ is at a gas pressure from 1.5-3.0 kg/m³, more preferably the CO₂ is at a gas pressure from 2.0-3.0 kg/m³.

In the method according to another embodiment of the third aspect of the invention, the gas pressure may be from 1.0-3.5 kgf/cm². Preferably the CO₂ is at a gas pressure from 1.5-3.0 kgf/cm², more preferably the CO₂ is at a gas pressure from 2.0-3.0 kgf/cm².

The method according to the third aspect of the invention may comprise preparing the beverage composition with any of the additional sweetening agents that have been listed above according to the first aspect of the invention.

The method according to the third aspect of the invention may comprise preparing the beverage composition with the addition of a buffer system, as described hereinbefore.

### Examples

A study was carried out as follows: samples were prepared comprising 50 ppm, 100 ppm, 150 ppm, 250 ppm, 500 ppm, 1000 ppm and 2500 ppm of Reb M. The samples were prepared in phosphate buffer and the pH was adjusted using phosphoric acid. Samples were prepared at the following pH; 1.8, 2.0, 2.5, 3.0 and 3.5.

The samples were incubated at 40° C. for 13 weeks. This incubation protocol should mimic the degradation at room temperature over 6 to 9 months. The amount of Reb M in each sample at T=0 was calculated by HPLC this was then used to calculate the amount of remaining Reb M in each sample at each specified time point. Aliquots were taken at 2, 4, 6 and 13 weeks and analysed by HPLC to determine the degradation of Reb M over the 13 week study.

TABLE 1

| | Reb M | | | |
|---|---|---|---|---|
| | conc | % degradation | % degradation | % degradation |
| pH | (% w/w) | 4 weeks | 6 weeks | 13 weeks |
| 1.8 | 0.025 | 72 | 87 | 99 |
| 1.8 | 0.05 | 72 | 87 | 98 |
| 1.8 | 0.12 | 71 | 87 | 98 |
| 1.8 | 0.25 | 70 | 87 | 98 |
| 2 | 0.005 | 70 | 82 | 97 |
| 2 | 0.01 | 68 | 81 | 97 |
| 2 | 0.015 | 63 | 77 | 98 |
| 2 | 0.025 | 57 | 77 | 96 |
| 2 | 0.05 | 59 | 76 | 96 |
| 2 | 0.12 | 57 | 77 | 95 |
| 2 | 0.25 | 58 | 76 | 95 |
| 2.5 | 0.005 | 25 | 29 | 55 |
| 2.5 | 0.01 | 21 | 30 | 61 |
| 2.5 | 0.015 | 23 | 31 | 54 |
| 2.5 | 0.025 | 21 | 29 | 47 |
| 2.5 | 0.05 | 19 | 26 | 50 |
| 2.5 | 0.12 | 18 | 25 | 50 |
| 2.5 | 0.25 | 19 | 24 | 49 |
| 3 | 0.005 | 11 | 16 | 27 |
| 3 | 0.01 | 11 | 17 | 27 |
| 3 | 0.015 | 10 | 12 | 24 |
| 3 | 0.025 | 10 | 11 | 22 |
| 3 | 0.05 | 8 | 11 | 23 |
| 3 | 0.12 | 9 | 10 | 23 |
| 3 | 0.25 | 5 | 9 | 19 |
| 3.5 | 0.005 | 6 | 7 | 10 |
| 3.5 | 0.01 | 4 | 6 | 9 |
| 3.5 | 0.015 | 3 | 5 | 10 |
| 3.5 | 0.025 | 5 | 6 | 10 |
| 3.5 | 0.05 | 2 | 4 | 9 |
| 3.5 | 0.12 | 3 | 3 | 7 |
| 3.5 | 0.25 | 1 | 4 | 7 |

Table 1 demonstrates the level of degradation observed by HPLC in the various Reb M samples at different pHs. There is a clear trend that the Reb M degrades faster at low pH. However, surprisingly there is also a trend that the lower concentration samples (50 ppm, 100 ppm) degrade more quickly over time. The higher concentrations (1200 ppm and 2500 ppm) were significantly more stable are pH 2.5 to 3.5.

1. A beverage composition comprising from 700 ppm to 2500 ppm of Reb M, and having a pH in the range of 2.0 to 3.5.

2. The beverage composition of claim 1, comprising from 800 ppm to 2500 ppm of Reb M.

3. The beverage composition of claim 1, comprising from 800 ppm to 2000 ppm of Reb M.

4. The beverage composition of claim 1, comprising from 900 ppm to 2000 ppm of Reb M.

5. The beverage composition of claim 1, comprising from 1000 ppm to 2000 ppm of Reb M.

6. A beverage composition concentrate comprising from 700 ppm to 2500 ppm of Reb M, and having a pH in the range of 2.0 to 3.5.

7. The beverage composition concentrate of claim 6, comprising from 1200 ppm to 2500 ppm of Reb M.

8. The beverage composition of claim 1, wherein the beverage comprises carbon dioxide gas at a gas pressure of 1.0-3.5 kgf/cm².

9. The beverage composition of claim 1, having a pH in the range of 2.5 to 3.0.

10. The beverage composition of claim 1, further comprising a sweetener selected from the group consisting of Reb A, Reb B, Reb C, Reb D, Reb E, stevioside, mogroside V, sucrose, HCFS, sucralose, aspartame, saccharine, acesulfame K, erythritol and combinations thereof.

11. The beverage composition of claim 1, further comprising caffeine, cinnamaldehyde, phosphoric acid or caramel coloring.

12. A method for improving the stability of Reb M in a beverage composition, comprising preparing a beverage comprising Reb M at a concentration of between 700 ppm to 2500 ppm and with a pH between 2.0 to 3.5.

13. The method of claim 12, comprising preparing a beverage comprising between 800 ppm to 2500 ppm Reb M.

14. The method of claim 12, comprising preparing a beverage comprising between 800 ppm to 2000 ppm of Reb M.

15. The method of claim 12, comprising preparing a beverage comprising between 1000 ppm to 2000 ppm of Reb M.

16. The method of claim 12, wherein the beverage comprises carbon dioxide gas at a gas pressure of 1.0-3.5 kgf/cm².

17. The method of claim 12, wherein the beverage has a pH in the range of 2.5 to 3.0.

18. The method of claim 12, wherein the beverage composition is a beverage concentrate.
